(19) United States
(12) Patent Application Publication
(10) Pub. No.: US 2019/0238410 A1
(43) Pub. Date: Aug. 1, 2019

(54) VERIFYING NETWORK INTENTS

(71) Applicant: Hewlett Packard Enterprise Development LP, Houston, TX (US)

(72) Inventors: Joon Myung Kang, San Jose, CA (US); Huazhe WANG, Santa Cruz, CA (US); Puneet SHARMA, Palo Alto, CA (US)

(21) Appl. No.: 15/885,202

(22) Filed: Jan. 31, 2018

(51) Int. Cl. H04L 12/24

(52) U.S. Cl. CPC H04L 41/0873; H04L 43/04; H04L 41/0853; H04L 41/0869

(57) ABSTRACT

A method for verifying network intents may include decomposing at least one network intent into a plurality of sub-verification tasks, generating a set of normalized configurations for a plurality of network devices in a target network based on a set of current configurations for the plurality of network devices and generating a network graph based on the set of normalized configurations and a topology of the target network. The method may further include analyzing the plurality of sub-verification tasks and the network graph to determine if the set of current configurations for the plurality of network devices satisfies the at least one network intent. If the at least one network intent is not satisfied, a report may be generated indicating that the target network is not in compliance. If the at least one network intent is satisfied, information may be provided indicating that target network is in compliance.

### BACKGROUND

Modern networks include different kinds of network devices, both physical and virtual, that may have multiple network functions and dynamic states. Intent-based management has been developed to manage networks by using network intents which are a desired outcome driven by business objectives in terms of “what we need” for a target network instead of low level implementations (i.e., “how to do”) to increase scalability and flexibility.

### BRIEF DESCRIPTION OF THE DRAWINGS

Various examples will be described below by referring to the following figures:

FIG. 1A is a block diagram of an example network intent verification system;

FIG. 1B is a block diagram of an example system for verifying network intents in a stateful network;

FIG. 2 is an example flowchart of a method for verifying network intents in a stateful network;

FIG. 3 is an example network intent using a graph model;

FIG. 4 is an example block diagram of a segmentation for decomposing a network intent;

FIG. 5 is an example block diagram of extensions for a data modeling language for normalization of network configurations;

FIG. 6 is an example network graph for two network functions; and

FIG. 7 is an example block diagram of slicing for decomposing a network intent.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Network administrators or operators may configure a managed network based on business goals or requirements using a set of network policies (e.g., security, performance, authentication, fault, etc.). However, these network policies are typically written with low-level identifiers (e.g., IP/Mac address, network protocols, etc.) to configure devices in the network. A low-level configuration defines “how” to configure the network (e.g., each network device) to accomplish the objective. For example, to configure a wireless network using low-level configurations or information to allow temporary visitors to access the network, all access points have to be configured manually with subtext information, access controls, performance metrics, etc. Low-level configurations may be difficult to maintain as the size of the network increases. To overcome these limitations, intent-based management has been developed to manage networks using network intents as the input from an administrator or operator. A network intent is a high level business policy or objective, namely, “what we need” for the target network. For example, to configure a wireless network to allow temporary access to the network, a network intent “configure networks for guests” may be defined without specifying all of the low-level configurations. A network intent will not need to be changed because of changes to the target network such as increasing the number of access points.

Networks may include a large number of network devices which may have multiple network functions and dynamic states. For intent-based management of a network, application of network intents involves the translation of the network intents to low-level configurations for each device. Typically, network intents may be expressed with technology-agnostic terms such as logical labels/tags (e.g., “configure networks for guests”) and low-level configurations may be implemented with technology-specific data such as IP/Mac address, CLI network command, etc. A network intent verification system and method may be provided to verify whether the current network configurations and rules can satisfy the given set of network intents. The verification system and method may, for example, use network intents from administrators and the current network configurations from the network devices. Accordingly, network administrators may check for violations of the desired network intents with the configurations of the target network. In one example, the network intent verification system and method may be used to check if the network intents are correctly translated or that the target network is working in an intentional manner. For example, for a network intent to allow Internet access from any device in a guest network, all network devices such as switches or firewalls should be set up to allow http/https traffic for any device in the guest network to the Internet. Devices may be dynamically presented in the guest network and may require a determination as to whether the low-level configurations are violated against the original network intent. In another example, the network intent verification system and method may be used to determine if the current configuration of the network devices are satisfying the network intents (e.g., if there is a change in the configuration of a network device for optimization such as optimizing by reducing overlapping header spaces).

A method for verifying network intents may comprise decomposing at least one network intent into a plurality of sub-verification tasks, generating a set of normalized configurations for a plurality of network devices in a target network based on a set of current configurations for the plurality of network devices, and generating a network graph based on the set of normalized configurations and a topology of the target network. The method may further comprise analyzing the plurality of sub-verification tasks and the network graph to determine if the set of current configurations for the plurality of network devices satisfies the at least one network intent. If the at least one network intent is not satisfied, a report may be generated indicating that the target network is not in compliance. If the at least one network intent is satisfied, information may be provided indicating that target network is in compliance.

A system for verifying network intents may comprise a decomposer to decompose at least one network intent into a plurality of sub-verification tasks, a configuration normalizer to generate a set of normalized configurations for a plurality of network devices in a target network based on a set of current configurations for the plurality of network devices and a network graph builder coupled to the configuration normalizer. The network graph builder may be used to generate a network graph based on the set of normalized configurations and a topology of the target network. The system may further comprise an SMT solver coupled to the decomposer and the network graph builder. The SMT solver may be used to analyze the set of normalized configurations and the network graph to determine violations of the at least one network intent by the set of current configurations for the plurality of network devices. The system may further comprise a violation analyzer coupled to the SMT solver. The violation analyzer may be used to generate a report identifying the violations.

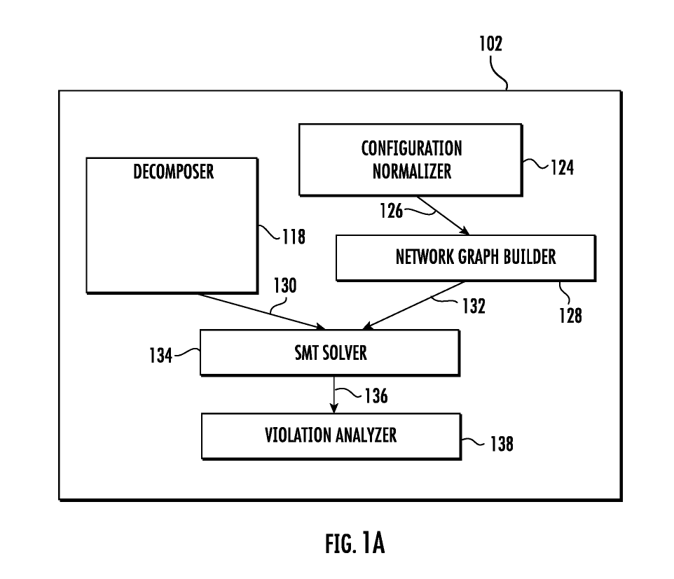

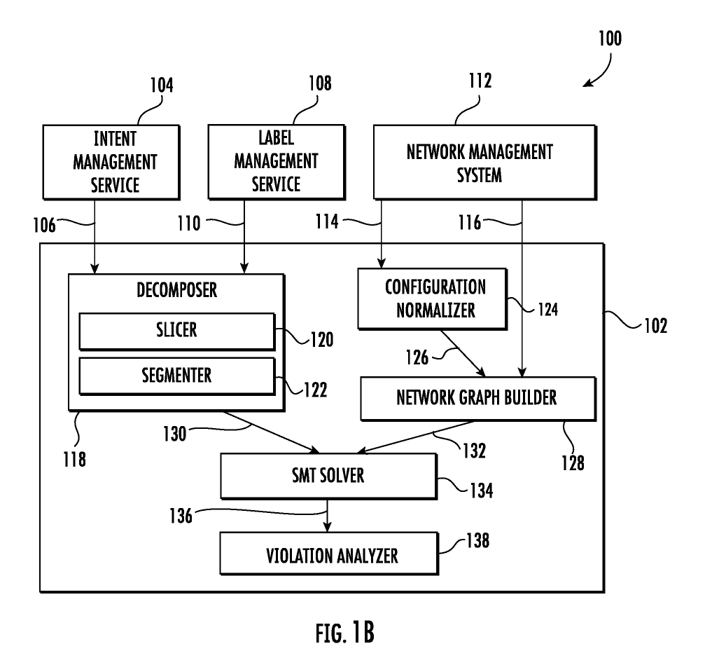

FIG. 1A is a block diagram of an example network intent verification system. Network intent verification system 102 is used to verify whether the current topology and configurations of a target network (not shown) are in compliance with the network intents defined by an administrator. Network intent verification system 102 includes a decomposer 118, a configuration normalizer 124, a network graph builder 128, an SMT (Satisfiability Modulo Theories) solver 134 and a violation analyzer 138. Operation of the network intent verification system 102 is described below.

FIG. 1B is a block diagram of an example system for verifying network intents in a stateful network. FIG. 1 shows a stateful network 100 utilizing intent-based management. A network intent verification system 102 is used to verify whether the current topology and configurations of the network 100 are in compliance with the network intents. Network intent verification system 102 may, for example, identify any violations, analyze the violations and generate a report regarding the violations. Network intent verification system 102 is coupled to and configured to receive inputs from an intent management service 104, a label management service 108 and a network management system 112.

Intent management service 104 is used by an administrator or operator to define network intents using logical labels rather than using low-level identifiers (e.g., IP/Mac addresses, machine ID, network protocols, etc.). A network intent may also be restricted by certain conditions (e.g., ACL rules, service type). The use of logical labels may provide a better abstraction and portability to the network intent expression and deployment. For example, a user A may have multiple network devices each of which has its own IP address. Without a logical label, all policies must be defined for all of the network devices of user A. However, a network intent may be defined using a logical label with the label “user A.” If, for example, the IP addresses of the network device are changed dynamically, the logical-label based network intent does not need to be updated to reflect the new IP addresses.

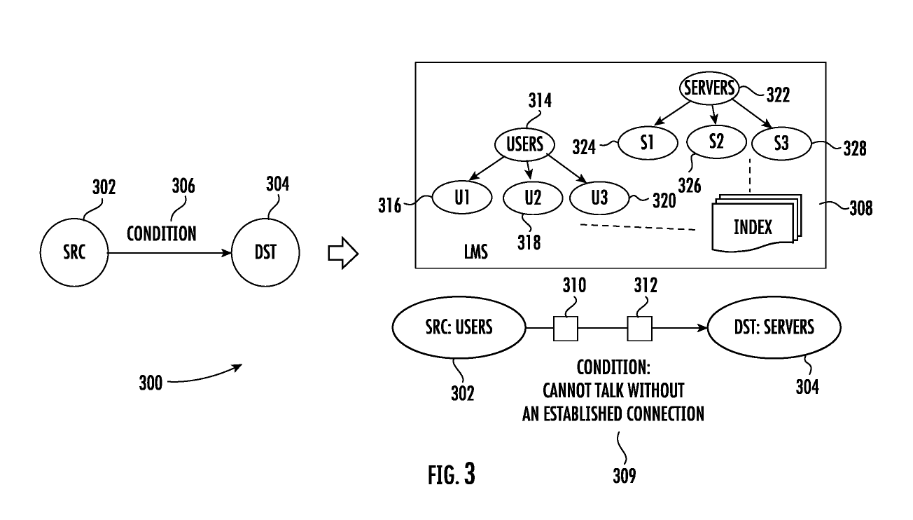

FIG. 3 shows an example network intent using a graph model. In FIG. 3, an example network intent 300 is shown using a Policy Graph Abstraction (PGA). A PGA may use logical labels which have a hierarchical relation from a label management service (LMS) 108 (shown in FIG. 1). In FIG. 3, a set of labels 308 and the hierarchical relation of the labels from an LMS are shown. Specifically, the set of labels includes the labels users 314, U1 316, U2 318, U3 320, servers 322, S1 324, S2 326 and S3 328. These labels 308 are used to define a network intent 300 for access control between a source 302 (e.g., users) and a destination 304 (e.g., servers) with a condition 306. A condition 306 may be, for example, reachability, isolation, waypoint, multipath consistency, locality, temporal logic, etc. In the example network intent 300 in FIG. 3, any user 302 (e.g., a device) may access the server 304 through a firewall 310 and NAT 312 with the condition 309 that the source 302 and destination 304 cannot communicate without an established connection. Returning to FIG. 1, the network intents 106 defined by the internet management service 104 are provided as an input to the network intent verification system 102.

The label management service 108 may be used to manage available logical labels, to map the labels to real low-level addresses (e.g., IP/Mac addresses or machine ID) or other low-level instantiation information and to update labels dynamically. Labels 110 from the label management service 108 are provided as an input to the network intent verification system 102. For example, the example labels in FIG. 3 are for users 314, servers 322 and their hierarchical relationship. The network management system 112 provides as inputs to the network intent verification system 102 all current configurations 114 for network devices, for example, switches or firewalls, and a whole network topology 116 which includes all connected links.

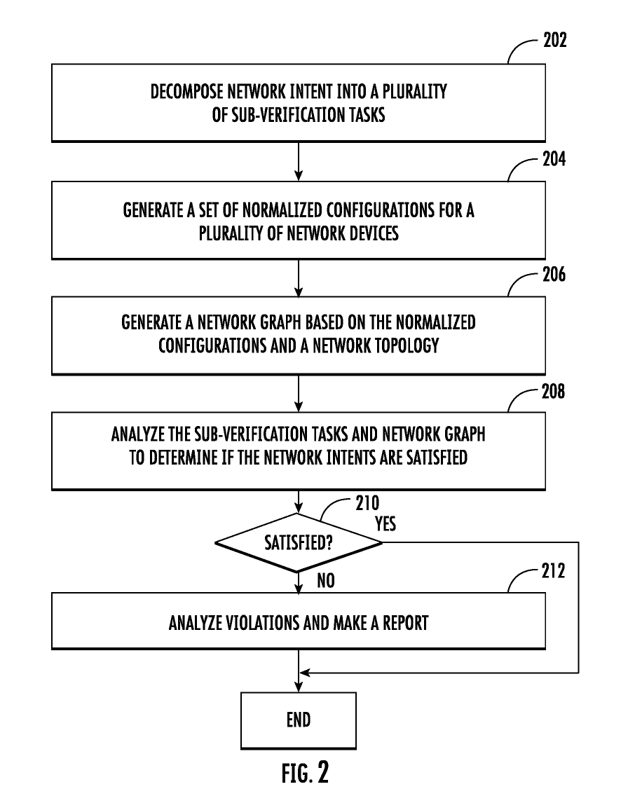

Network intent verification system 102 includes a decomposer 118, a configuration normalizer 124, a network graph builder 128, an SMT (Satisfiability Modulo Theories) solver 134 and a violation analyzer 138. Decomposer 118 receives as inputs the network intents 106 from intent management service 104 and label information 110 from label management service 108. Decomposer 118 is configured to decompose the network intents into multiple sub-verification tasks 130 that are provided as an input to the SMT solver 134. The sub-verification tasks 130 are generated by the decomposer 118 using slicing and segmentation. Accordingly, decomposer 118 may include a slicer 120 and a segmenter 122. Slicer 120 is configured to identify what portions of the network intent to check for intent verification. The process of slicing a network intent is described further below with respect FIG. 2. Segmenter 122 is configured to further reduce the size of the verification task by dividing the network into multiple segments which do not have any dependency. The process of segmentation is described further below with respect to FIG. 2.

The configuration normalizer 124 receives current configurations 114 for the network devices in a target network from the network management system 112 and converts the current configurations 114 into normalized configuration 126 using a data modeling language (for example, YANG) to create a common information model. The normalized configurations 126 are input to a network graph builder 128. The network graph builder 128 is configured to construct a graph model based on the normalized configurations 126 and the topology 116 provided from the network management system 112. In an example, the network graph builder 128 builds a first order logic representation graph model 132 of the network that is provided as an input to the SMT solver 134. The SMT solver 134 is configured to check for violations using the sub-verification tasks 130 and the graph model 132. In an example, the SMT solver 134 is a Z3 SMT solver. If the SMT solver 134 identifies a violation of the network intents (e.g., the current configuration is not in compliance with the network intents), the SMT solver 134 will provide the violations to the violation analyzer 138. If ether is no violation, the network verification system 102 may provide information indicating the target network is verified. The violation analyzer 138 is configured to analyze any violation(s) 136 and to generate a report that may be, for example, used by an administrator to find a root cause for the violation(s).

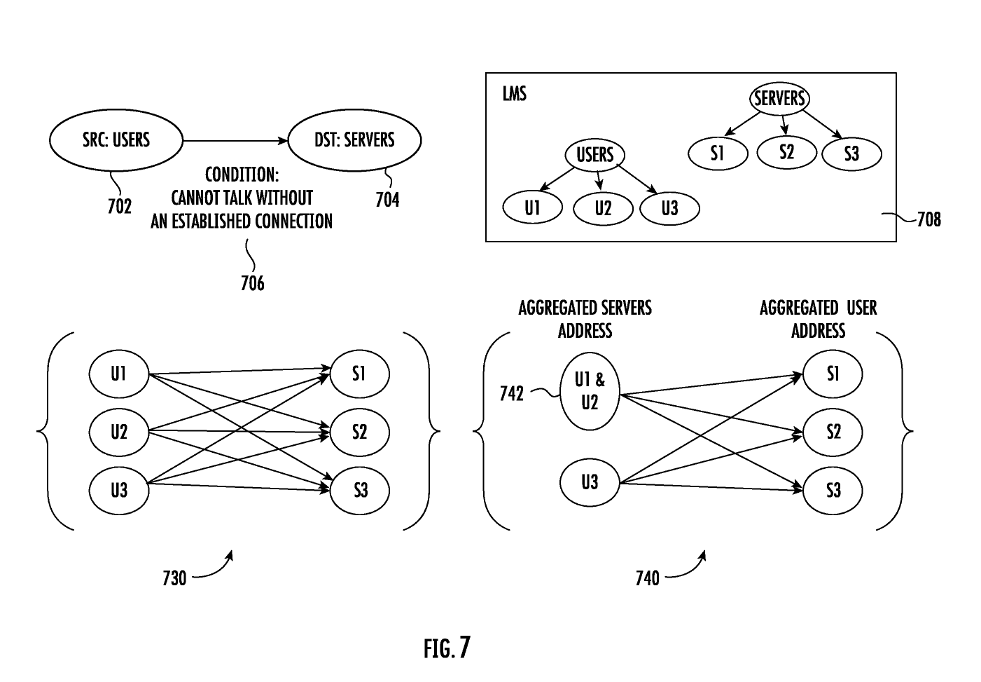

FIG. 2 is an example flowchart of a method for verifying network intents in a stateful network. The example method shown in FIG. 2 may be implemented by, for example, a network intent verification system 102 as described above with respect to FIG. 1. The verification method may be performed, for example, each time a new network intent is configured and put into a network by the intent management service, when a change is made to a network intent or when a change is made to the topology of a network. In another example, an administrator may schedule the verification method to be performed periodically, e.g., every five minutes. At block 202, network intents are decomposed into a plurality of sub-verification tasks using, for example, network intents from an intent management service and label information from a label management service. Label information and end hosts may be extracted from the label management service. In one example, a network intent is decomposed using slicing and segmentation. Slicing identifies what portions of the network intent to check for intent verification. A slicing operation divides verification tasks by address spaces for the source and destination nodes. For example, label information and end host lists may be extracted from an LMS and used to convert the network intent into sub-verification tasks. Each slice may be shared with the reachability within a set of end hosts. FIG. 7 is an example block diagram of slicing for decomposing a network intent. In FIG. 7, an example network intent 700 is shown for access control from users 702 to servers 704 with the condition 706 that users 702 cannot access servers 704 without an established connection. A slicing operation is used to determine how many possible verification tasks are between a source 702 and destination 704 node in the network intent 700. A set of labels or label tree 708 from an LMS shows there are three users (U1, U2 and U3) and three servers (S1, S2 and S3). The label tree 708 is used to determine what needs to be verified for the given network intent 700. In one example, if U1 and U2 are sharing address spaces, the result 740 for the slicing may include a slice for the nodes U1 and U2 as one source 742. In the result 740, there are six verification tasks (U1/U2 to S1, U1/U2 to S2, U1/U2 to S3, U3 to S1, U3 to S2 and U3 to S3). In another example, if there is no shared address between nodes, the result 730 of the slicing operation includes all slices for the combinations between users (U1, U2 and U3) and servers (S1, S2 and S3). In FIG. 7, there are nine verification tasks in the result 730 (U1 to S1, U1 to S2, U1 to S3, U2 to S1, U2 to S2, U2 to S3, U3 to S3, U3 to S2 and U3 to S3).

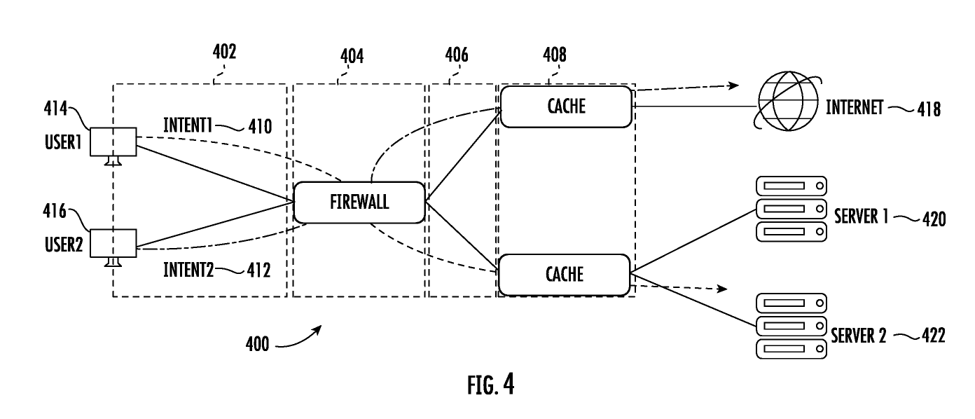

Segmentation further reduces the size of the verification task by dividing the target network into multiple segments which do not have any dependency. If any previous node's state affects the next node, it has a dependency. Each segment may then be verified step-by-step as discussed further below. FIG. 4 is an example block diagram of a segmentation for decomposing a network intent. In FIG. 4, the example segmentation 400 involves a first network intent 410 and a second network intent 412 for sources (e.g., users 414, 416) and destinations (e.g., Internet 418, servers 420, 422). The segmentations 400 is divided into four segments based on a tasks connectivity and a functional block which does not have any dependency: 1) Users-Firewall 402, 2) Firewall 404, 3) Firewall-Cache 406 and 4) Cache 408. Instead of verifying the entire intent (e.g., the entire path from User1 414 to Server 2 422 through Firewall and Cache with one verification task), a sub-verification task for each segment 402, 404, 406, 408 may be performed step-by-step to reduce processing time. If there is any violation during the verification, the remaining verification tasks for the remaining segments do not need to be performed. The results of the slicing and segmentation converts (or decomposes) the network intent(s) into a plurality of sub-verification tasks.

Returning to FIG. 2, at block 204 a set of normalized configurations for a plurality of network devices from multiple vendors in the target network is generated based on a set of current configurations for the plurality of network devices. The configurations for network functions (or middleboxes may vary across devices and vendors. For example, firewall devices from different vendors may have a syntactically different command to block a suspicious packet but the semantic is the same. Accordingly, different syntaxes for the low-level configurations of the network functions (or middleboxes) are converted to a set of normalized configurations using a data modeling language to create a common information model. In one example, a set of mapping rules between the low-level configurations and normalized configurations may be created manually. The common information model allows different configuration formats for network devices, such as network functions, to be normalized to create a standard representation of the network function configurations. The normalized configurations may allow support of third party tools which analyze and validate configuration data. In one example, the data modeling language may be a data modeling language commonly used such as the YANG language proposed by IETF such as OpenConfig YANG that may be modified (or extended) to support network function configurations

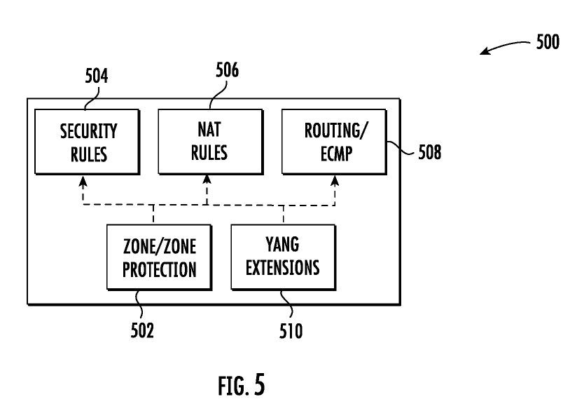

Extensions to the data modeling language may be designed to cover, for example, typical functions for both simple open source and advanced commercial network functions. FIG. 5 is an example block diagram of extensions for a data modeling language for normalization of network configurations. The extensions 500 include the following function units: Zone 502, Security Rules 504, NAT Rules 506, Routing/ECMP 508 and YANG extensions 510. The design of the Zone 502 function unit may be a security zone component with policy rules that are applied between zones. A zone is a grouping of interfaces (physical or virtual) that represents a segment of the network that is connected to, and controlled by the network function. Security Rules 504 are individual policy rules that determine whether to block or allow a session based on traffic attributes such as the source and destination security zone, the source and destination IP address, the application and the service. The NAT Rules 506 allow the translation of private, non-routable IPv4 addresses to one or more globally-routable IPv4 addresses thereby conserving an organizations routable IP addresses. The NAT rules allow the prevention of the disclosure of the real IP addresses of hosts that need access to public addresses and to manage traffic by performing port forwarding. For the Routing/ECMPO 508, equal cost multiple path (ECMP) processing is a network feature that uses multiple equal-cost routed to the same destination. The YANG extension 510 are other necessary extension that may be added into the existing YANG model.

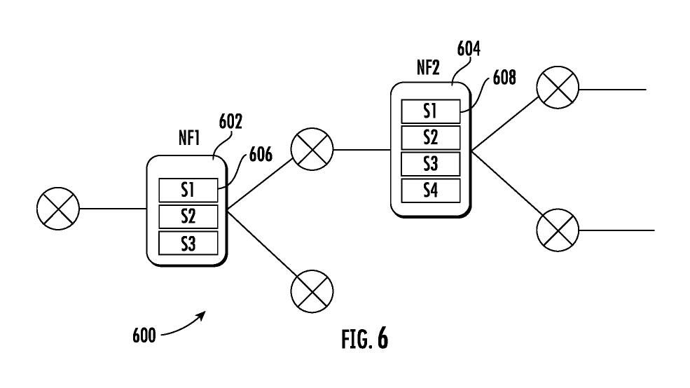

Returning to FIG.2, at block 206 a network graph of the target network is generated (or built) based on the normalized configurations and a network topology provided by, for example, a network management system. In an example, the network graph is a first order logic representation graph model of the target network. The network graph includes nodes and edges where, for example, the nodes may represent network devices such as a switch or network function (e.g., a firewall, load balancer) and the edges indicate the connections between nodes. The network graph may, for example, provide all connectivity and consistency information with first order logic. FIG. 6 is an example network graph for two network functions. In FIG. 6, the network graph 600 includes a first network function 602 with three states and a second network function 604 with four states. The network graph 600 may provide consistency information of the states between two network functions for verification. In an example, a first state 606, S1, of the first network function 602 may be consistent with a second state 608, S2, of the second network function 604 and may be checked concurrently or simultaneously.

Returning to FIG. 2, at block 208 the set of sub-verification tasks and the network graph are analyzed to determine if the current configurations for the plurality of network devices satisfy the network intents. In one example, an SMT solver may be used to check for violations of the network intents. The SMT solver may utilize a formula built using the sub-verification tasks and the network graph in the analysis to identify whether the current configurations of the network devices are in compliance with the network intents (i.e., to identify any violations). An example formula that may be analyzed by the SMT solver is:

F= [symbol] Λ ¬ [symbol] Eqn. 1

Where N is the sub-verification tasks and P is the normalized configurations. In an example, each of the normalized configurations may be tagged with a corresponding network intent using the data modeling language (e.g., YANG). The tags may be used to trace back the intent that generates the configuration. If the SMT solver determines that there are no violations (i.e., the network intents are satisfied by the current configurations) at block 210, information may be provided to, for example, an administrator, that indicates the target network is verified. If the SMT solver identifies a violation or multiple violations at block 210, the SMT solver may, for example, generate a counter example that identifies the problematic configuration. At step 212, the violation(s) may be analyzed and a report generates that may be used by, for example, an administrator to identify a root cause of the violation(s).

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

We claim:

1. A method for verifying network intents comprising:
decomposing at least one network intent into a plurality of sub-verification tasks;
generating a set of normalized configurations for a plurality of network devices in a target network based on a set of current configurations for the plurality of network devices;
generating a network graph based on the set of normalized configurations and a topology of the target network;
analyzing the plurality of sub-verification tasks and the network graph to determine if the set of current configurations for the plurality of network devices satisfies the at least one network intent;
if the at least one network intent is not satisfied, generating a report indicating that the target network is not in compliance; and
if the at least one network intent is satisfied, providing information indicating that target network is in compliance.

2. The method according to claim 1, wherein decomposing at least one network intent further comprises slicing the at least one network intent into a plurality of portions for verification.

3. The method according to claim 2, wherein decomposing the at least one network intent further comprises segmenting the target network into a plurality of segments.

4. The method according to claim 1, wherein generating the set of normalized configurations further comprises converting the set of current configurations to the set of normalized configurations using a data modeling language.

5. The method according to claim 4, wherein the data modeling language is YANG.

6. The method according to claim 4, wherein data modeling language includes at least one extension directed to at least one function of a network function.

7. The method according to claim 1, wherein an SMT solver is used to analyze the set of sub-verification tasks and the network graph to determine if the set of current configurations for the plurality of network devices satisfies the at least one network intent.

8. The method according to claim 1, wherein decomposing at least one network intent into a plurality of sub-verification tasks includes receiving the at least one network intent and receiving a set of labels.

9. The method according to claim 8, wherein the at least one network intent is defined by an intent management service and the set of labels are generated by a label management service.

10. The method according to claim 1, wherein the set of current network configurations and the topology of the target network are provided by a network management system.

11. A system for verifying network intents comprising:
a decomposer to decompose at least one network intent into a plurality of sub-verification tasks;
a configuration normalizer to generate a set of normalized configurations for a plurality of network devices in a target network based on a set of current configurations for the plurality of network devices;
a network graph builder coupled to the configuration normalizer, the network graph builder to generate a network graph based on the set of normalized configurations and a topology of the target network;
an SMT solver coupled to the decomposer and the network graph builder, the SMT solver to analyze the set of normalized configurations and the network graph to determine violations of the at least one network intent by the set of current configurations for the plurality of network devices; and
a violation analyzer coupled to the SMT solver, the violation analyzer to generate a report identifying the violations.

12. The system according to claim 11, wherein decomposing the at least one network intent comprises slicing the at least one network intent into a plurality of portions for verification.

13. The system according to claim 12, wherein decomposing the at least one network intent further comprises segmenting the target network into a plurality of segmentsr.

14. The system according to claim 11, wherein generating the set of normalized configurations comprises converting the set of current configurations to the set of normalized configurations using a data modeling language.

15. The system according to claim 14, wherein the data modeling language is YANG.

16. The system according to claim 14, wherein data modeling language includes at least one extension directed to at least one function of a network function.

17. The system according to claim 11, wherein the decomposer receives the at least one network intent from an intent management service.

18. The system according to claim 11, wherein the decomposer receives a set of labels from a label management service.

19. The system according to claim 11, wherein the configuration normalizer receives the set of current network configurations from a network management system.

20. The system according to claim 11, wherein the network graph builder receives the topology of the target network from a network management system.
